(19) United States
(12) Patent Application Publication
(10) Pub. No.: US 2003/0030924 A1
(43) Pub. Date: Feb. 13, 2003

(54) REFLECTING MIRROR

(75) Inventor: Noboru Takahashi, Tokyo (JP)

Correspondence Address: Jordan and Hamburg, 122 East 42nd Street, New York, NY, 10168, US

(73) Assignee: TAKAROKU SHOJI CO.,LTD.

(21) Appl. No.: 09/925,341

(22) Filed: Aug. 9, 2001

(51) Int. Cl. G02B 5/08; G02B 7/182

(52) U.S. Cl. 359/871; 359/838; 359/881

(57) ABSTRACT

An attaching part of a reflecting mirror is fixed to a guardrail of a road. A solar of a solar-powered light emitter accumulates electricity by sunlight of the daytime, and the light emitting diode emits light at nighttime. Therefore, when the front panel is irradiated with headlight of an automobile running at nighttime, the light is reflected off the diamond cut of the rear surface, in particular, then the light is reflected off the surface of the inner panel on which reflecting surface work is made, and the reflected light is irregularly reflected by the diamond cut surface of the rear surface of the front panel, thereby functioning as a driving sign of the running automobile in combination with the emitted light from the light emitting diode. Furthermore, the dirt adhered to the front surface of the front panel is automatically peeled off because of the self purification effect of titanium oxide with which the front surface is coated. Therefore, the reflecting property of the reflecting mirror is improved and exerted for a long time.

### BACKGROUND OF THE INVENTION

The present invention relates to a reflecting mirror which reflects headlight of automobile, the reflecting mirror being attached, for example, to a guardrail, roadside or medial strip of a road in use.

Heretofore, reflecting mirrors which reflects headlight of automobile have been attached to guardrails or fences of road. Various kinds of reflecting mirrors have been proposed: the first conventional example is that a front panel having a reflecting property is attached to a front opening of a bowl-like holding part constituting the main body of the reflecting mirror; the second example is that specular working is made on the inner surface of the holding part for improving the reflection efficiency; and the third example is that a bulb is placed inside the holding part. These are used as signs for car driving at nighttime and useful for safety of driving. Many of these conventional reflecting mirrors are attached on the front surface with a transparent reflecting panel into which a fluorescent pigment is mixed and of which rear surface is prism worked. Therefore, while such a reflecting mirror is attached to a guardrail, as the reflecting surface will become dirty in short time by splashes of mud water from the road surface and by pollutants contained in rain and air, the reflecting efficiency will deteriorate. This makes it difficult to ensure the safety driving of automobile in bad conditions such as nighttime or raining. In view of the above, in recent years, the fourth conventional example wherein a supporting shaft is projected at the center of the front panel, and a wind wheel having a brush is rotatably attached to the supporting shaft has been already put into practical use. Since the wind wheel can rotate by wind and the brush can clean the front panel by this rotation, such configuration is very useful for keeping the reflecting property.

However, in the second conventional example in which specular-working such as vapor-deposition or plating is made on the inner surface of the holding part, covering portions such as the rear surface of the holding member, on which such vapor-deposition or plating is not to be made, is required in order that those portions do not become dirty at the time of vapor-deposition or plating. Such a preparation is complicated and significantly affects the production costs. In the third conventional example in which a bulb is placed inside the holding part, electric wiring work is required. In the fourth conventional example utilizing the reflecting mirror with wind wheel, splashes of mud water from the road surface and pollutants in rain and air will easily go into the bearing between the supporting shaft and the wind wheel, which makes the wind wheel not rotate smoothly and finally unable to rotate. As a result, the reflecting surface becomes dirt and the reflecting efficiency deteriorates, and such reflecting mirror does not contribute to ensure the safety of car driving at nighttime.

Furthermore, it is currently required to recycle scrapped synthetic resin parts, packages and the like of automobiles and household-electrical appliances from the view point of making effective use of resources. It has been found that the material of the reflecting mirror according to the present invention is satisfactory in the point of strength even when recycled synthetic resins are used.

### BRIEF SUMMARY OF THE INVENTION

In view of the above, it is an object of the present invention to provide a reflecting mirror capable of decreasing the production cost, eliminating the necessity of electric wiring and capable of keeping the reflecting efficiency for a long time.

It is another object of the present invention to improve the reflecting efficiency of the reflecting mirror and to keep the reflecting efficiency for a long time. In particular, when the front surface of a front panel is coated with titanium oxide, the front surface is prevented from becoming dirty, so that it is possible to provide a reflecting mirror capable of keeping the reflecting efficiency for the longer time.

It is yet another object of the present invention to provide a reflecting mirror in which its holding part, attaching part and inner panel is formed out of recycled synthetic resin and such application enables use of recycled synthetic resin much wider.

The first brief description of the reflecting mirror according to the present invention comprises a holding member, an inner panel, a front panel and a solar-powered light emitter, the holding member being formed of a synthetic resin, having a hollow holding part with front surface opening and a attaching part for attaching to other members; the holding part being formed with a housing; the inner panel being a plate having a through hole and having a front surface formed into a reflecting surface; the front panel being formed of a transparent plastic material; the inner panel being provided in parallel with the front surface opening of the holding part in the holding part; the solar-powered light emitter being inserted into the housing of the holding part via the through hole of the inner panel; the front panel being attached to the front surface opening of the holding part.

The second brief description of the present invention is that the front surface of the front panel is coated with titanium oxide.

The third brief description of the present invention is that diamond cut is made on the rear surface of the front panel. This diamond cut surface comprehends any surface that irregularly reflects or exerts a prism effect.

The fourth brief description of the present invention is that the holding member and the inner panel are formed of a recycled synthetic resin material.

### BRIEF DESCRIPTION OF THE SEVERAL VIEWS OF THE DRAWING

FIG. 1 is a partially cutaway view in perspective of the entire reflecting mirror.

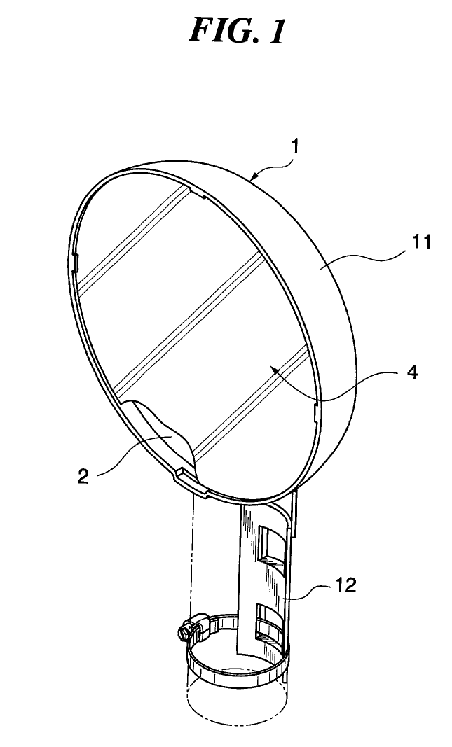

FIG. 2 is an enlarged front view showing the state that the reflecting panel is removed from the holding part.

FIG. 3 is an enlarged section view along the perpendicular center line of the reflecting mirror.

FIG. 4 is a front view of an inner panel.

FIG. 5 is an enlarged front view of a solar-powered light emitter.

FIG. 6 is a section view along the line a-a of FIG. 5.

FIG. 7 is an enlarged section view of the reflecting panel.

### DETAILED DESCRIPTION OF THE INVENTION

First, the explanation of configuration of a holding member 1 will be made. This holding member is formed of a material such as polypropylene, polystyrene, ABS and the like, and if materials that have been recycled by a recycle system preferably from scrapped parts of automobiles and household electrical appliances, plastic packages and the like are used for the material of the holding member, it is possible to broaden the recycling range of recycled synthetic resins.

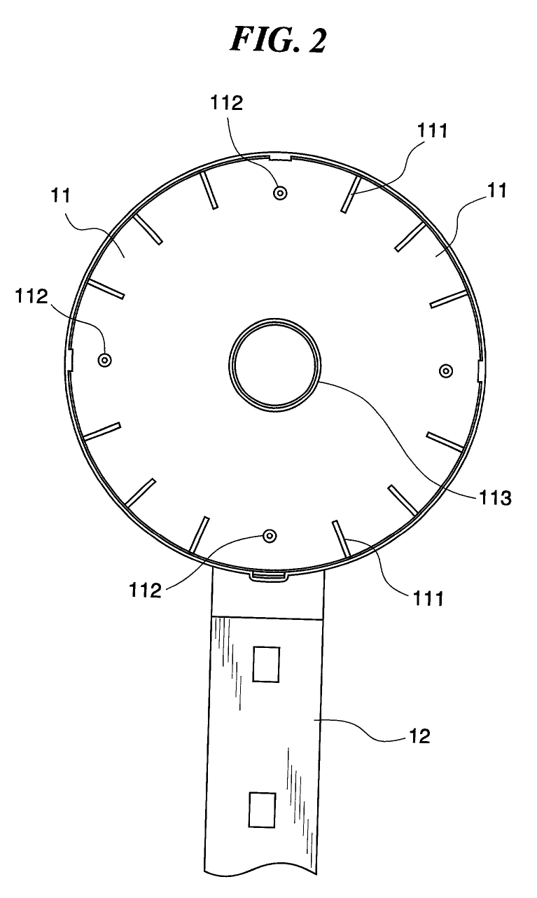

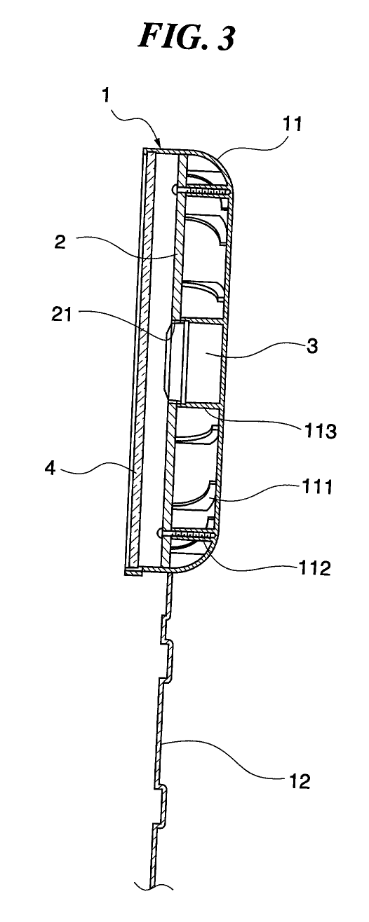

The upper half part of the holding member 1 is a holding part 11 which is a bowl-like hollow member with forward opening, and the lower half thereof is an attaching part 12 capable of being attached to a supporting shaft of a guardrail or a fake-wood column made of scrapped plastic. As shown in FIGS. 2 and 3, the inner surface of the holding part 11 is so configured that a plurality of ribs 111 are radially formed at predetermined angular displacements in the peripheral part of the inner wall surface; attaching columns (bosses) 112 are provided in four positions, that is, upper, lower, left and right positions in protruded manner; and a circular housing 113 is formed in the center of the holding part 11, whose interior is the housing of a solar-powered light emitter 3. The top surfaces of the ribs 111, the attaching columns 112 and the housing 113 are the same level as shown in FIG. 3.

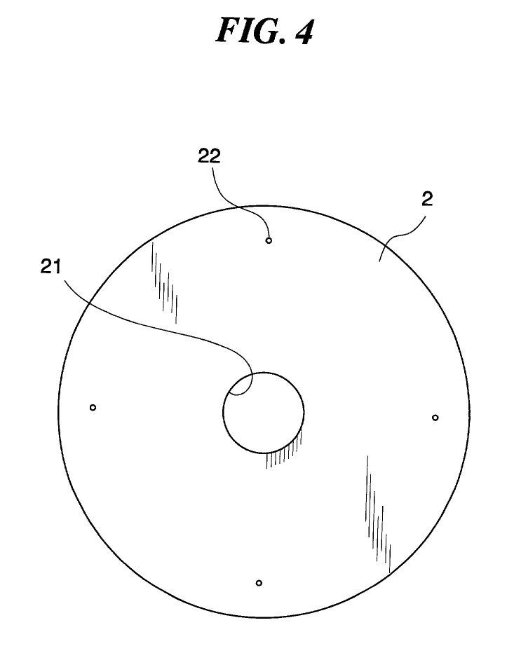

As shown in FIGS. 3 and 4, the inner panel 2 is a disc-like member capable of being set adjacent to the inner wall of the holding part 11. As shown in FIG. 4, a through hole 21 is pierced at the center portion, and attaching small holes 22 are provided in four positions, that is, at the upper, the lower, the left and the right. The through hole 21 is of the size and the shape corresponding to those of the housing 113, and the attaching small holes 22 are provided in the positions corresponding to the attaching columns 112. The front surface of the inner panel 2 is a reflecting surface, whose property is worked by plating, or by putting a hot stamp foil, that is, a foil obtained by adhering a foil on which aluminum or chromium is vapor deposited on the surface of the film. Incidentally, chromium plating or chromium vapor deposition is preferred from the point of preventing the reflecting surface from turning black.

The surface of the inner panel 2 is formed into a reflecting surface by specular working. And the present invention proposes the inner panel described below in order to make specular work on the surface of the inner panel formed of a plastic material of single grade with high dimensional accuracy at the time of forming the inner panel for eliminating the necessity of applying an undercoat agent as a pretreatment of vapor deposition of the specular working, thereby improving the heat resistance of the inner panel, and decreasing the shrinkage of the inner panel.

The inner panel 2 is obtained by forming a granular plastic material consisting of a plastic and an inorganic additive added thereto, and performing specular working on the surface thereof. The plastic is either one selected from olefinic resins, ABS resin and styrol resin. The olefinic resins are, for example, polyethylene or polypropylene.

The additive is selected from oxides, hydroxides, carbonates, sulfates, silicates, nitrides, carbons and potassium titanate. The detailed explanation of additive is as follows.

The “oxides” mean one or plural oxide(s) selected from diatomaceous earth, alumina, magnesium oxide, titanium oxide, zinc oxide and antimony oxide. The “hydroxides” mean one or plural hydroxide(s) selected from magnesium hydroxide, aluminum hydroxide and basic magnesium carbonate. The “carbonates” mean one or plural carbonate(s) selected from calcium carbonate, magnesium carbonate and barium carbonate. The “sulfates” mean one or plural sulfate(s) selected from calcium sulfate, calcium sulfite and barium sulfate, and the “silicates” mean one or plural silicate(s) selected from calcium silicate, talc, kaolin clay, mica, zeolite, attapulgite, bentonite, sericite, aluminum silicate, feldspar powder, magnesium silicate and apatite. The “nitrides” mean silicon nitride, and the “carbons” mean selected from carbon black and graphite.

Next, the amount of those additives to be added will be explained.

The amount of addition of silica, diatomaceous earth, alumina and magnesium oxide of the oxides is in the range of 20 to 60% by weight, the amount of addition of titanium oxide, zinc oxide and antimony oxide of the oxides is in the range of 25 to 70% by weight, the amount of addition of the hydroxides is in the range of 20 to 60% by weight, the amount of addition of calcium carbonate and magnesium carbonate of the carbonates is in the range of 20 to 60% by weight, the amount of addition of barium carbonate of the carbonates is in the range of 25 to 70% by weight, the amount of addition of calcium sulfate and calcium sulfite of the sulfates is in the range of 20 to 60% by weight, the amount of addition of barium sulfate of the sulfates is in the range of 25 to 70% by weight, the amount of addition of the silicates is in the range of 20 to 60% by weight, the amount of addition of the nitrides is in the range of 20 to 60% by weight, the amount of addition of the carbons is in the range of 10 to 50% by weight, and the amount of addition of the potassium titanate is in the range of 20 to 60% by weight.

These limitations for the amount of addition are defined so as to ensure the adhesion power of vacuum plating and the peel strength of electrolytic plating, nonelectrolytic plating and spattering deposition, and so as to prevent the mechanical properties of the plastic product itself such as tensile yield strength, tensile rupture strength, break elongation, bending strength and bend elastic constant from deteriorating.

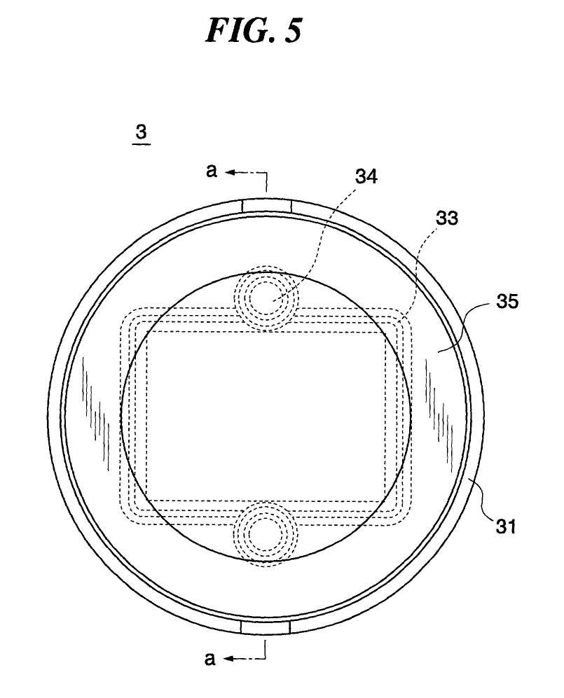

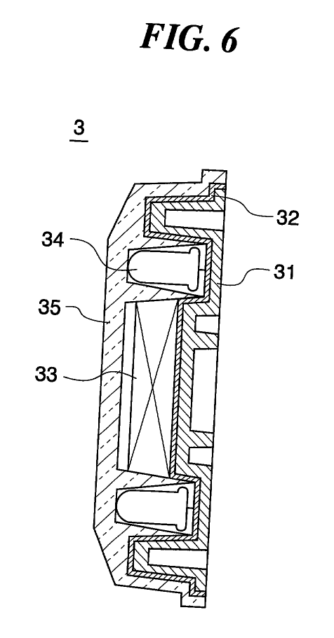

Inside the housing 113 is attached the solar-powered light emitter 3 as shown in FIG. 3 via the through hole 21 of the inner panel 2. The solar-powered light emitter 3 is shown in FIGS. 5 and 6, where a reflecting sheet 32 is adhered to a substrate 31; a solar 33 is provided in the center part; and light emitting diodes (LED) 34 which emit light by this solar are provided in two positions, that is the upper and lower positions. Then a transparent upper case 35 is fitted to the substrate 31.

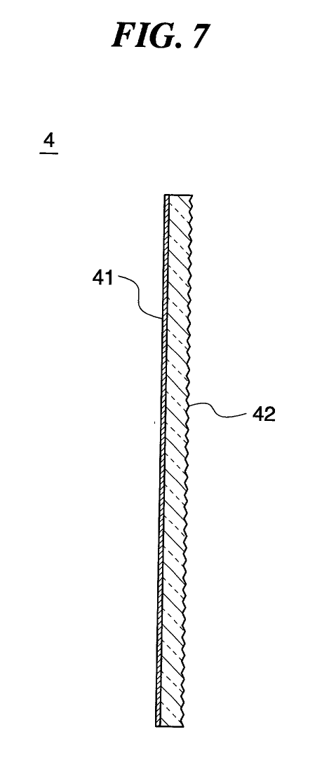

Next, referring to FIG. 7, front panel 4 will be explained. The front panel 4 is formed of a transparent plastic material such as polycarbonate resin or acrylic resin. The front surface thereof is coated with titanium oxide. Both sides of the front panel 4 may be smooth. However, it is particularly preferable that the rear surface of the front panel 42 has a cut surface on which diamond cut is made to provide prism effect from the view points of light reflecting efficiency, reflecting direction and performance. Titanium oxide is a photocatalyst which catalyzes decomposition of harmful substances by means of optical energy, and has been known to be effective in deodorization, antibacterial and air cleaning. In the present invention, the front surface 41 of the front panel 4 is coated with the titanium oxide. As this coating surface has been found out having the property of self-cleansing by the present inventor, the mud water and the like on the reflecting panel comes off and is cleaned up by this effect, this effect is employed in the present invention.

For assembling the reflecting mirror, the solar-powered light emitter 3 is press-fitted into the housing 113 of the holding part 11 of the holding member 1 and fixed there. Next, the inner panel 2 is inserted into the holding part 11 along the inner wall thereof, and the through hole 21 of the inner panel is fitted with the apex of the solar-powered light emitter 3. Then, a tap screw is screwed into the attaching column 112 from the small hole 22, and the inner panel is fixed with being contacted with the top surface of the rib 111. Furthermore, the front panel 4 is fitted, press-fitted and fixed to the front surface opening of the holding part 11.

The reflecting mirror having the above configuration is disposed with its attaching part 12 fixed to a guardrail or a fake-wood column of the roadside made of scrapped plastic with using belt, bolt and nut at an angle enabling the reflecting mirror to reflect headlight of automobile. The solar 33 of the solar-powered light emitter 3 accumulates the electricity by the sunlight of daytime, and the light emitting diode 34 emits light at nighttime. Therefore, when the light from the automobile headlights meets the front panel 4 at nighttime, the light is reflected off the surface of the inner panel 2 on which reflecting surface work is made. Then, the reflected light is irregularly reflected by the diamond-cut surface of the rear surface of the front panel 4, thereby functioning as a driving sign of the running automobile. The solar-powered light emitter 3 is effective for duplicating the function as a driving sign. Furthermore, the dirt adhered to the front surface 41 of the front panel 4 is cleaned up by the self-cleansing effect of titanium oxide with which the front surface is coated.

1. A reflecting mirror comprising:
a holding member formed of a synthetic resin, having a hollow holding part with front surface opening and a attaching part for attaching to other members;
a housing formed in the holding part;
a inner panel provided in parallel with the front surface opening of the holding part in the holding part, the inner panel being a plate having a through hole and having a front surface formed into a reflecting surface;
a solar-powered light emitter inserted into the housing of the holding part via the through hole of the inner panel; and
a front panel formed of a transparent plastic material attached to the front surface opening of the holding part.

2. The reflecting mirror according to claim 1, wherein the front surface of the front panel is coated with titanium oxide.

3. The reflecting mirror according to claim 1, wherein diamond cut is made on the rear surface of the front panel.

4. The reflecting mirror according to claim 1, wherein the holding member and the inner panel are formed of a recycled synthetic resin material.

5. The reflecting mirror according to claim 1, wherein the inner panel is obtaining by forming a granular plastic material consisting of a plastic and an inorganic additive added thereto, and performing specular work on the surface thereof, the being selected from olefinic resins, ABS resin and styrol resin, the additive being selected from oxides, hydroxides, carbonates, sulfates, silicates, nitrides, carbons and potassium titanate.

6. The reflecting mirror according to claim 5, wherein the specular work is a work selected from deposition by aluminum or chromium, spattering deposition, electrolytic plating and nonelectrolytic plating.

7. The reflecting mirror according to claim 5, wherein the specular work is to adhere a hot stamp foil on which specular work selected from deposition by aluminum or chromium, spattering deposition, electrolytic plating and nonelectrolytic plating has been previously made.

8. The reflecting mirror according to claim 5, wherein the oxides are selected from diatomaceous earth, alumina, magnesium oxide, titanium oxide, zinc oxide and antimony oxide.

9. The reflecting mirror according to claim 5, wherein the hydroxides are selected from magnesium hydroxide, aluminum hydroxide and basic magnesium carbonate.

10. The reflecting mirror according to claim 5, wherein the carbonates are selected from calcium carbonate, magnesium carbonate and barium carbonate.

11. The reflecting mirror according to claim 5, wherein the sulfates are selected from calcium sulfate, calcium sulfite and barium sulfate.

12. The reflecting mirror according to claim 5, wherein the silicates are selected from calcium silicate, talc, kaolin clay, mica, zeolite, attapulgite, bentonite, sericite, aluminum silicate, feldspar powder, magnesium silicate and apatite.

13. The reflecting mirror according to claim 5, wherein the nitrides are silicon nitride and the carbons are selected from carbon black and graphite.

14. The reflecting mirror according to claim 5, wherein the amount of addition of silica, diatomaceous earth, alumina and magnesium oxide of the oxides is in the range of 20 to 60% by weight, the amount of addition of titanium oxide, zinc oxide and antimony oxide of the oxides is in the range of 25 to 70% by weight, the amount of addition of the hydroxides is in the range of 20 to 60% by weight, the amount of addition of calcium carbonate and magnesium carbonate of the carbonates is in the range of 20 to 60% by weight, the amount of addition of barium carbonate of the carbonates is in the range of 25 to 70% by weight, the amount of addition of calcium sulfate and calcium sulfite of the sulfates is in the range of 20 to 60% by weight, the amount of addition of barium sulfate of the sulfates is in the range of 25 to 70% by weight, the amount of addition of the silicates is in the range of 20 to 60% by weight, the amount of addition of the nitrides is in the range of 20 to 60% by weight, the amount of addition of the carbons is in the range of 10 to 50% by weight, and the amount of addition of the potassium titanate is in the range of 20 to 60% by weight.
